(19) United States
(12) Patent Application Publication
(10) Pub. No.: US 2004/0106823 A1
(43) Pub. Date: Jun. 3, 2004

(54) Novel phosphonium phosphinate compounds and their methods of preparation

(76) Inventors: Allan James Roberstson, Ontario (CA); Kenneth Richard Seddon, Donaghadee (GB)

Correspondence Address: Cytec Industries Inc, Patent Law Department, 1937 West Main Street, PO Box 60, Stamford, CT, 06904-0060, US

(21) Appl. No.: 10/473,271

(22) PCT Filed: Feb. 28, 2002
(86) PCT No.: PCT/US02/06104

(30) Foreign Application Priority Data
Mar. 30, 2001 (CA) 2343456

(51) Int. Cl. C07F 9/22; C07F 9/28

(52) U.S. Cl. 562/8; 562/9

(57) ABSTRACT

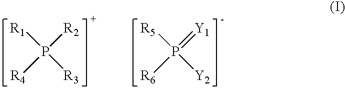

Novel phosphonium phosphinate compounds and their methods of preparation are disclosed. Phosphonium salts are ionic liquids that are useful as polar solvents. The novel phosphonium phosphinate compounds have general formula (I), wherein R₁, R₂, R₃, R₄, R⁵ and R₆ is independently a hydrogen or hydrocarbyl, unsubstituted or substituted; Y₁ is O or S; and Y₂ is O or S.

### FIELD OF THE INVENTION

### BACKGROUND OF THE INVENTION

Low melting or liquid phosphonium salts have found utility as polar solvents known as “ionic liquids.” Ionic liquids provide an attractive potential alternative to traditional organic solvents for chemical reactions for many reasons. For industrial purposes, the low vapour pressure of ionic liquids is a very important feature. They are essentially non-volatile, a property that eliminates many of the containment problems typically encountered with traditional organic solvents. Since ionic liquids are often composed of poorly coordinating ions, they have the potential to provide a highly polar yet poorly coordinating solvent. Moreover, many of these solvents are immiscible with traditional organic solvents and therefore provide a non-aqueous polar alternative to two-phase systems. Because of their distinctive solvent characteristics, they can be used to bring unusual combinations of reagents into the same phase. A recent review of the properties and uses of ionic liquids is provided in an article entitled “Room-Temperature Ionic Liquids. Solvents for Synthesis and Catalysis,” by Thomas Welton (Chem. Rev. 1999, 99, 2071-2083).

Ionic liquids provide solvents with a wide liquid range and a high degree of thermal stability. However, there remains a need for increasing the solvent options available to chemists by developing novel ionic liquids with distinctive physical and chemical properties.

### SUMMARY OF THE INVENTION

The current invention provides novel phosphonium phosphinate compounds and methods of preparing these compounds. The phosphonium phosphinate compounds can have a broad range of phosphonium cations and a broad range of phosphinate and dithiophosphinate anions.

The novel phosphonium phosphinates have the general formula (I):

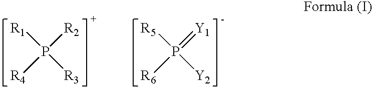

wherein:

each of R₁, R₂, R₃, R₄, R₅, and R₆ is independently a hydrogen atom or a hydrocarbyl group, provided that not more than two of R₁ to R₄ and not more than one of R₅ and R6 are hydrogen;

Y₁ is O or S; and

Y₂ is O or S.

Preferably, each of R₁ to R₆ is a hydrocarbyl group.

In another aspect, the invention provides a process for preparing a phosphonium phosphinate compound of formula (I), as defined above, wherein:

i) a compound of formula (II):

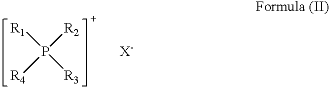

wherein R₁ to R₄ are as defined above, and X⁻ is a leaving group, is reacted with

ii) a compound of the formula (IV):

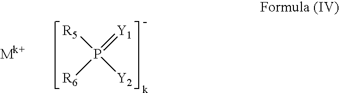

wherein , R₅, R₆, Y₁ and Y₂ are as defined in formula (I), and

M^{k+} is H⁺ or a metal cation with valency “k”. Preferably, if M^{k+} is H⁺ and X⁻ is a leaving group other than OH⁻, then the reaction is carried out in the presence of a base. A base is not needed if X⁻ is OH⁻ and M^{k+} is H⁺. If M^{k+} is a metal cation with valency “k”, then X⁻ is a leaving group other than OH⁻.

Thus, in one embodiment, compounds according to formula (I) can be prepared by reacting:

i) a compound of formula (II):

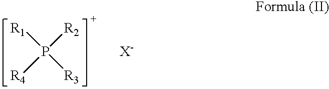

wherein R₁ to R₄ are as defined above for formula (I) and

X⁻ is a leaving group, for example hydroxide (OH-), acetate, sulfate, or a halide, preferably chloride, bromide or iodide,

with

ii) a compound of formula (III):

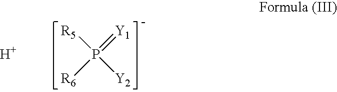

wherein R₅, R₆, Y₁, and Y₂ are as defined above for formula (I), and

when X³¹ of formula (II) is any leaving group other than OH⁻, with

iii) a base, for example a hydroxide or a carbonate of an alkali metal or alkaline earth metal.

In another embodiment, compounds according to formula (I) can also be prepared by reacting a compound of the formula (II), as defined above, with ii) a compound of the formula (IV):

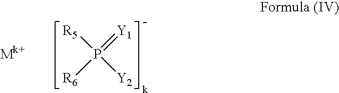

wherein R₅, R₆, Y₁ and Y₂ are as defined above for formula (I), and

M^{k+} is ammonium or a metal and k is the valency of the metal. Appropriate metals are any metals that form water-soluble salts with anions, for example, alkali metals, preferably Na⁺ or K⁺.

In another aspect of the invention, the compounds according to formula (I) are useful as ionic solvents.

### BRIEF DESCRIPTION OF DRAWINGS

Having generally described the nature of the invention, preferred embodiments will now be described with reference to the accompanying drawings, in which:

FIG. 1 shows the results of a TGA assay on trihexyl(tetradecyl)phosphonium bis(2,4,4′-trimethyl-pentyl)phosphinate.

FIG. 2 shows the results of a TGA assay on trihexyl(tetradecyl)phosphonium diisobutylphosphinate.

FIG. 3 is a ³¹p NMR spectrum of trihexyl(tetradecyl)phosphonium dicyclo-hexylphosphinate.

FIG. 4 shows the results of a thermogravimetric analysis (TGA) assay on trihexyl(tetradecyl)phosphonium dicyclohexylphosphinate.

FIG. 5 is a ³¹p NMR spectrum of trihexyl-(tetradecyl)phosphonium diisobutyldithiophosphinate.

FIG. 6 shows the results of a TGA assay on trihexyl(tetradecyl)phosphonium diisobutyldithiophosphinate.

### DESCRIPTION OF PREFERRED EMBODIMENTS

The current invention concerns compounds of the general formula (I), as defined above, wherein: each of R₁, R₂, R₃, R₄, R₅, and R₆ is independently a hydrogen or hydrocarbyl group; Y₁ is O or S; and Y₂ is O or S. It is possible for the groups R₁ to R₆ to bear substituents, or to include heteroatoms, provided that the substituents or heteroatoms do not interfere with the preparation of the compounds of the invention, and do not adversely affect the desired properties of the compound. Acceptable substituents include alkoxy, alkylthio, acetyl, and hydroxyl groups, and acceptable heteroatoms include oxygen and sulphur. Substituents are likely to increase the cost of the compounds of the invention and as the compounds are often used as solvents, they are used in such volume that cost is a significant factor. Hence, it is contemplated that, for the most part, substituents will not be present.

Preferably, each of R₁, R₂, R₃, R₄, R₅, and R₆ is independently an alkyl group of 1 to 30 carbon atoms, a cycloalkyl group of 3 to 7 carbon atoms, an alkenyl group of 2 to 30 carbon atoms, an alkynyl group of 2 to 30 carbon atoms, an aryl group of 6 to 18 carbon atoms, or an aralkyl group.

Alkyl groups that exceed 18 carbon atoms, especially those that exceed 20 carbon atoms, are likely to increase costs. Since cost is a significant factor in producing a solvent, it is contemplated that, for practical purposes, the alkyl groups will typically not exceed 20 carbon atoms. Therefore, more preferred are compounds according to formula (I) wherein each of R₁, R₂, R₃, R₄, R₅, and R₆, is independently an alkyl group of 5 to 20 carbon atoms. For example, R₁, R₂, R₃, R₄, R₅, and R6 may be n-butyl, isobutyl, n-pentyl, cyclopentyl, isopentyl, n-hexyl, cyclohexyl, (2,4,4′-trimethyl)pentyl, cyclooctyl, tetradecyl, etc., although it is preferred that at least one of R₁ to R₄ contains a higher number of carbon atoms, for example 14 or more. In many cases, it is desired that R₁ to R₄ shall not be identical. For many purposes, it is desired that at least one of R₁ to R₄ shall contain a significantly higher number of carbon atoms than the others of R₁ to R₄. Compounds in which R₁ to R₄ are not identical are referred to as asymmetric.

For many applications, it will be preferred that Y₁ and Y₂ are both O. For example, in chemical reactions that utilize certain metal catalysts such as.Pd(OAc)₂, it will be preferred that Y₁ and Y₂ are both O because the presence of thio groups in the phosphinate anion may interfere with the action of the catalyst. Phosphonium thiophosphinate compounds find utility as solvents for chemical reactions that do not involve metal catalysts.

Preferred compounds include compounds according to formula (I) wherein each of R₁, R₂, R₃, R₄, R₅, and R₆, is independently an aryl group or substituted aryl group. For example, one or more of R₁, R₂, R₃, R₄, R₅, and R₆ may be phenyl, phenethyl, xylyl, or naphthyl.

For some purposes, compounds according to formula (I) that are hydrophobic or “water immiscible” are preferred. The term “water immiscible” is intended to describe compounds that form a two phase system when mixed with water but does not exclude ionic liquids that dissolve in water nor ionic liquids that will dissolve water, provided that the two phase system forms. Therefore, compounds that have a large total number of carbons, equal to or greater than 20 and in particular greater than 25 or 26, or have at least one aryl group are preferred because they are more hydrophobic. Water immiscibility is a desirable feature of phosphonium phosphinates not only because it renders the compounds useful for biphasic reactions with an aqueous phase, but also because it facilitates purification and isolation of the phosphonium phosphinate when prepared according to certain methods. There is no critical upper limit on the total number of carbon atoms that may be present in R₁ to R₆. However, it is unlikely that the total will exceed 50.

For many purposes, a material that is a liquid at room temperature is very valuable. Preferred compounds, therefore, are those in which the particular groups R₁ to R6 are selected to yield compounds that are liquid at room temperature. Selection of particular values for R₁ to R₆ to achieve particular melting points and degrees of water immiscibility is within the competence of a person skilled in the art, although it may require some routine experimentation. For example, the degree of asymmetry and branching of the hydrocarbyl groups R₁ to R₆ of the phosphonium cation or phosphinate anion are important determinants of the melting point: the melting point tends to decrease as the degree of asymmetry and branching is increased. Branching can occur at the alpha or omega carbon or at any intermediate point. Increasing the total number of carbon atoms present in the hydrocarbyl groups R₁ to R₆ will tend to increase the melting point, although this effect will be counteracted somewhat by assymetry and branching. For instance, the properties of compounds whose phosphonium cation contains four decyl groups as R₁ to R₄ will differ from those of a compound having three undecyl groups and one heptyl, despite the fact that both cations have a total of 40 carbon atoms.

For some purposes, compounds according to formula (I) that have chirality may be especially preferred, as they further provide a chiral environment for chemical reactions. Examples include compounds in which one of R₁ to R6 is an enantiomer of 2,4,4′-trimethylpentyl, which has one chiral atom.

Examples of preferred compound according to formula (I) include those in which:

each of R₁, R₂, and R₃ is n-hexyl and R₄ is n-tetradecyl and

R₅ and R6 are 2,4,4′-trimethylpentyl and Y₁ and Y₂ are O; or

R₅ and R₆ are isobutyl and Y₁ and Y2 are O; or

R₅ and R₆ are cyclohexyl and Y₁ and Y₂ are O; or

R₅ and R₆ are isobutyl and Y₁ and Y₂ are S.

The current invention also provides methods for preparing the phosphonium phosphinate compounds according to formula (I). In general, phosphonium phosphinates can be prepared by reacting a phosphonium salt of formula (II) with either: 1) a phosphinic acid of formula (III) and a base, or 2) a phosphinate salt of formula (IV). Alternatively, phosphonium phosphinates can be prepared by reacting a phosphonium hydroxide of formula (II) with a phosphinic acid. The temperature of the reaction is not critical, but the reaction is conveniently done at elevated temperature, up to about 100° C., preferably in the range of 45-70° C. Use of a higher temperature facilitates phase separation.

If a phosphonium phosphinate is immiscible with water, it can be prepared by first mixing a phosphonium salt of formula (II) with a phosphinic acid compound of formula (III) and water, with stirring or other means of mixing, then adding a base. The mixture is stirred for an additional period. When mixing is stopped, the reaction mixture will separate into an organic phase that contains the phosphonium phosphinate product and an aqueous phase. The aqueous phase can be decanted, and the organic phase can then be washed with water to remove the salt byproducts formed by the reaction (for example, sodium chloride). If desired, residual water can be removed from the organic layer by, for example, vacuum-stripping.

In a variation of the method described above, the phosphonium salt and water are mixed together first, then sodium hydroxide is added, and the phosphinic acid is added last. When mixing is stopped, the reaction mixture will separate into an aqueous phase and organic phase that can be processed further as described in the method above.

Phosphonium phosphinates according to formula (I) that are immiscible with water can also be prepared by mixing a phosphonium salt of formula (II) with a phosphinate salt of formula (IV) and water, with stirring. The mixture is stirred for an additional period, say one hour. When mixing is stopped, the reaction mixture will separate into aqueous and organic layers. The aqueous layer can be decanted, and the organic layer can be washed several times with water, to remove any remaining [M⁺] [X⁻]ₖ. If desired, dissolved water can be removed from the organic layer by, for example, vacuum-stripping.

Another preferred method can be used to prepare phosphonium phosphinates that are either miscible or immiscible with water. Phosphonium phosphinates according to formula (I) can be prepared by reacting a phosphonium hydroxide of formula (II), i.e. a compound of formula (II) in which X⁻ is OH⁻, with a phosphinic acid of formula (III) to produce a phosphonium phosphinate and water. The water produced by this acid-base reaction can be removed by, for example, vacuum-stripping. Since phosphonium phosphinates produced by this method do not have to be washed with water to remove salt, this method can be used to prepare phosphonium phosphinates that are either miscible or immiscible with water. This method is preferred for preparing phosphonium phosphinates that have a small total number of carbons, of the order of 7 to 10 carbons.

It should be noted that the compounds of formula (I) contain up to six hydrocarbyl groups R₁ to R₆. The particular properties of a compound of formula_(I) depend upon the values taken by these six groups. Selection of different values for these groups therefore permits fine tailoring of the properties of the compound of the invention. Hence compounds can be designed to be liquid at a particular temperature and to be water-immiscible. Change in the value of one or more of the groups R₁ to R₆ can effect change in these properties. The presence of six groups for this purpose is advantageous when compared with known ionic liquids based on dialkylimidazolium cations, which have only two groups that can be varied.

For the most part compounds of the invention have a density less than 1. Consequently, they form the upper phase of two phase systems with water. In this respect, they differ from known ionic liquids based on dialkyl imidazolium cations, which tend to have a density greater than 1 and therefore form the lower phase of two phase systems with water.

The phosphonium phosphinate salts of the current invention may be used as polar solvents. In a preferred embodiment, phosphonium phosphinates of the current invention can be used as polar solvents for chemical reactions such as Michael additions, aryl coupling, Diels-Alder, alkylation, biphasic catalysis, Heck reactions, hydrogenation, or for enzymatic reactions, for example lipase reactions.

In the following examples (see Examples 5 and 6), it will be shown that the phosphonium phosphinates of the current invention are suitable solvents for the synthesis of biphenyl via homo-coupling of bromobenzene or iodobenzene. Biaryls are of great importance in synthetic organic chemistry, as they have found many industrial and pharmacological applications. Elaboration of liquid crystals, for example, often relies on the synthesis of a biaryl framework. Among the natural products biophenomycin and steganacin posses this biaryl molecular substructure. Hence, their production in a cost- effective fashion is especially important. The Ullman Synthesis of biaryls typically demands high temperature conditions (200° C.) and requires equimolar amounts of copper. The use of palladium catalysts and an appropriate ionic solvent, such as the phosphonium phosphinates of the current invention, may avoid the need for stoichiometric amounts of metal and high temperature.

In Example 8, the suitability of the phosphonium phosphinates as solvents for palladium catalyzed carbonylation is demonstrated. The palladium catalyzed carbonylation reactions of aryl-X derivatives constitute a powerful method of C-C coupling reaction for the synthesis of various aromatic carboxylate acid derivatives such as amides and esters. The aryl palladium species formed as the intermediate undergoes the facile CO insertion, followed by the nucleophilic attack of alcohol, water, and amines to give the acid, esters and amides respectively. This reaction can be carried out using aryl halide with carbon monoxide and a nucleophile in the presence of catalytic amount of a palladium compound. Other metal catalysts derived from Co and Ni have also been used as catalysts.

As can be seen from the following examples, some of which are in accordance with the invention and some of which are comparative, yields vary with choice of solvent in the various reactions. In many of the examples, the phosphonium phosphinates of the present invention give good, or best, results. Hence they provide a valuable enhancement in methods of synthesis.

### EXAMPLES

### Example 1

trihexyl(tetradecyl)phosphonium bis(2,4,4′-trimethylpentyl)-phosphinate

Trihexyl(tetradecyl)phosphonium bis(2,4,4′-trimethyl-pentyl)phosphinate was prepared according to the following method. A 5 liter stirred jacketed reactor was charged with:

1.880 moles of trihexyl(tetradecyl)phosphonium chloride

(1003 g of CYPHOS 3653 containing 97.2% trihexyl(tetradecyl)phosphonium chloride)

1.875 moles of bis(2,4,4′-trimethylpentyl)phosphinic acid

(625 g of CYANEX 272 containing 87% bis(2,4,4′-trimethylpentyl)phosphinic acid)

and 1369 g of water.

After heating the mixture to 54° C., a 25% aqueous sodium hydroxide solution (82.3 g of 97% sodium hydroxide (two moles), 236.8 g water) was added over about 32 minutes. The two phases were stirred for an additional ½ hr at 55° C.

The agitation was then turned off and the reaction mixture was allowed to separate into a two-phase system consisting of an upper organic phase and a lower aqueous phase (phase separation took about 2 minutes). The lower aqueous phase was decanted and the upper organic layer was washed three times with about 1300 g of distilled water per wash, by stirring for one hour at 55° C. The amount of time required for bulk phase separation increased with each successive wash: 2 minutes, 30 minutes, then for the final wash, 8 minutes was required to achieve bulk separation but 22 hours was required for the organic layer to clear.

After washing and allowing the phases to separate, the organic layer was then vacuum stripped to remove dissolved water. Approximately 230 g of water (13.2% by weight) was removed after vacuum stripping to 125° C. under 4 mmHG pressure. The final organic layer was perfectly clear.

### Results

The aqueous phase was analyzed for chloride ion (see Table 1). The first decant removed 82.9% of the chloride ion. The first, second, and third washes additionally removed 12.0%, 1.7%, and 0.2% of the chloride ion, respectively, for a total of 96.7%.

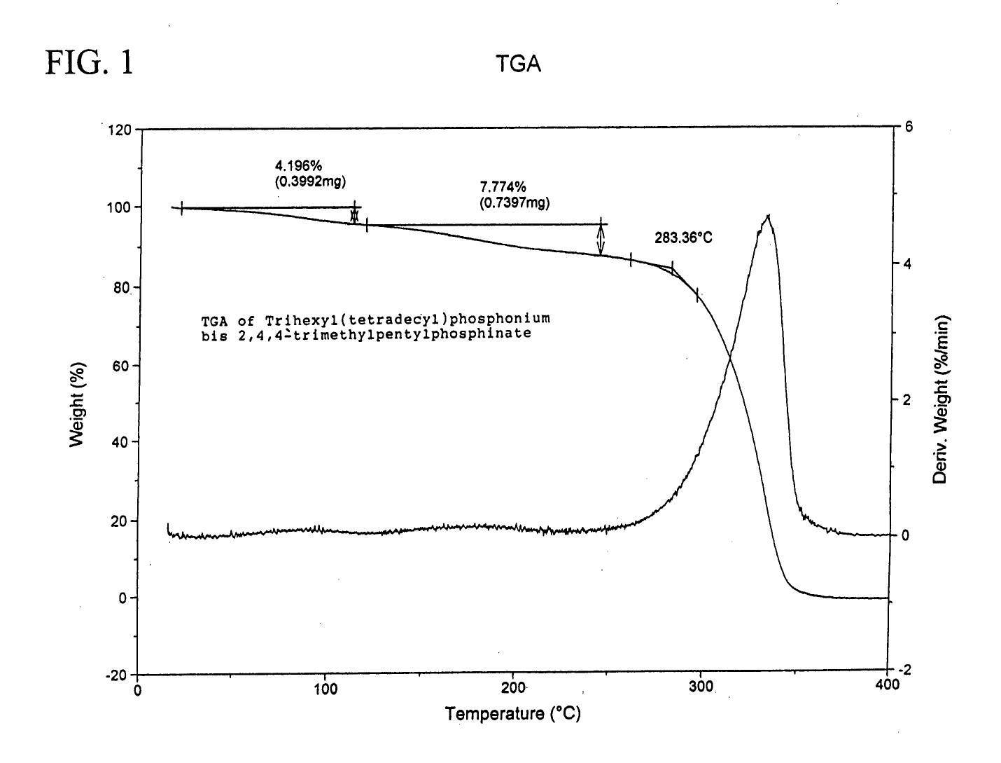

Samples of trihexyl(tetradecyl)phosphonium bis(2,4,4′-trimethylpentyl) phosphinate were analyzed by TGA and found to be thermally stable up to approximately 300° C. (see FIG. 1). This analysis also indicated that the product may contain as much as 4-6% moisture.

TABLE 1
Preparation of trihexyl(tetradecyl)phosphonium bis (2,4,4′-
trimethylpentyl)phosphinate

| | | |
|---|---|---|
| bis (2,4,4′- | 87.0% R″₂P(O)OH | R″ = bis 2,4,4′- |
| trimethylpentyl) | | trimethylpentyl |
| phosphinic acid | | |
| (CYANEX 272) | | |
| CYPHOS 3653 | 97.2% R₃R′PCl | R = n-butyl |
| | 2.1% R₃PCl | R′ = n-tetradecyl |
| | 0.2% HCl | |

| | | | Chloride Balance | | |
|---|---|---|---|---|---|
| | Weight | | | Moles | % Cl |
| | (g) | Moles | % Cl | Cl | Removed |
| CYANEX 272 | 625 | 1.875 | | 0.000 | |
| CYPHOS 3653 | 1003 | 1.880 | | 1.946 | |
| 97% NaOH | 82.3 | 1.996 | | 0.000 | |
| Water | 1605 | | | | |
| 1st decant | 1404 | | 4.0720 | 1.613 | 82.9 |
| 2nd decant | 1283 | | 0.6450 | 0.233 | 12.0 |
| 3rd decant | 1305 | | 0.0873 | 0.032 | 1.7 |
| 4th decant | 1303 | | 0.0096 | 0.004 | 0.2 |
| Total | | | | 1.882 | 96.7 |

### Example 2

trihexyl(tetradecyl)phosphonium diisobutylphosphinate

Trihexyl(tetradecyl)phosphonium diisobutylphosphinate was prepared according to the following method. A 5 liter stirred jacketed reactor was charged with:

2.004 moles of trihexyl(tetradecyl)phosphonium chloride

(1069 g of CYPHOS 3653)

2.004 moles of diisobutylphosphinic acid

(390.8 g of 91.3% diisobutylphosphinic acid) and

1114 g of water

After heating the mixture to 55° C., a 25% aqueous solution of sodium hydroxide (87.7 g of 97% sodium hydroxide (two moles), 240 g water) was added over 30 minutes. The two phases were stirred for an additional 1 hr at 55° C.

The agitation was then turned off and the reaction mixture was allowed to separate into a two-phase system consisting of an upper organic phase and a lower aqueous phase (phase separation took about 2 minutes). The lower aqueous phase was decanted and the upper organic layer was washed three times each with about 1300 g of distilled water by stirring for one hour at 55° C. The amount of time required for bulk phase separation increased with each successive wash. After washing, the organic and liquid phases were cloudy initially but cleared upon standing overnight.

After washing and allowing the phases to completely separate, the organic layer was then vacuum stripped to remove dissolved water. Approximately 13.4% water by weight was removed after vacuum stripping to 135° C. under 4 mmHG pressure. The final organic layer was perfectly clear.

### Results

The decanted aqueous phases were analyzed for chloride ion (see Table 2). The first decant removed 63.7% of the chloride ion. The first, second, and third washes additionally removed 5.3%, 0.3%, and 0.2% of the chloride ion, respectively, for a total of 69.5%.

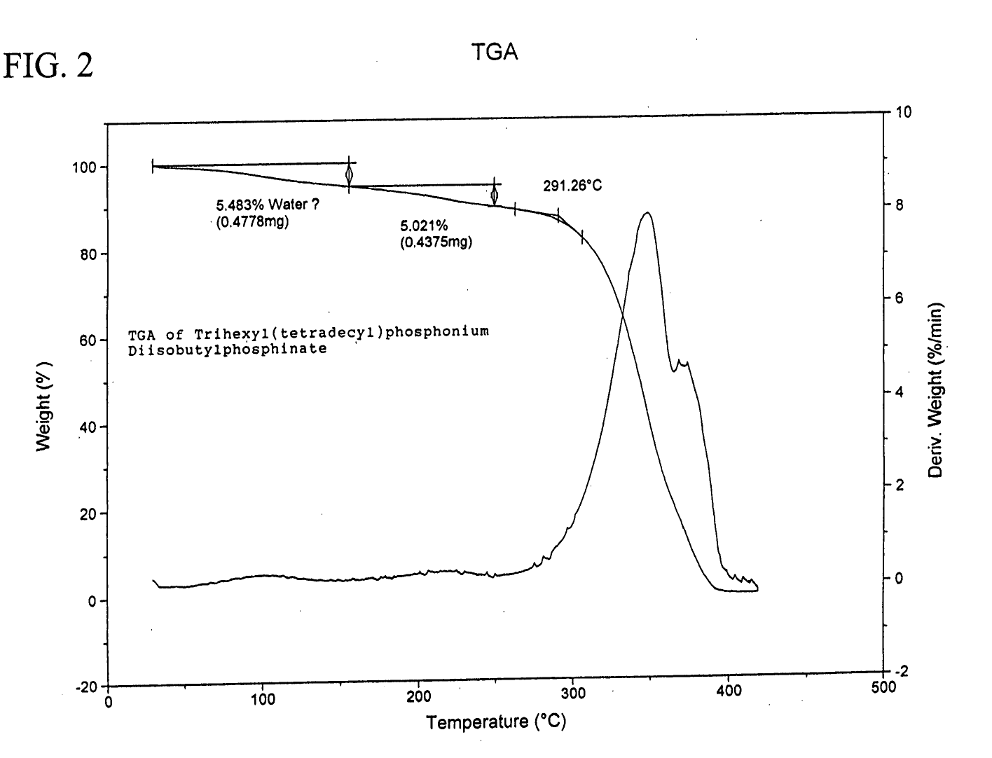

Samples of trihexyl(tetradecyl)phosphonium diisobutylphosphinate were analyzed by TGA and found to be thermally stable up to approximately 300° C. (see FIG. 2). This analysis also indicated that the product may contain as much as 4-6% moisture.

TABLE 2
Preparation of trihexyl(tetradecyl)phosphonium
diisobutylphosphinate

| | | |
|---|---|---|
| Diisobutylphosphinic | 91.3% R″₂P(O)OH | R″ = isobutyl |
| acid | | |
| CYPHOS 3653 | 97.2% R₃R′PCl | R = n-butyl |
| | 2.1% R₃PCl | R′ = n- |
| | | tetradecyl |
| | 0.2% HCl | |

| | Weight | | Chloride Balance | | % Cl |
|---|---|---|---|---|---|
| | (g) | Moles | % Cl | Moles Cl | Removed |
| R″₂P(O)OH | 390.8 | 2.004 | | 0.000 | |
| CYPHOS 3653 | 1069 | 2.004 | | 2.074 | |
| 97% NaOH | 87.7 | 2.127 | | 0.000 | |
| Water | 1354 | | | | |
| 1st decant | 1245 | | 3.7610 | 1.321 | 63.7 |
| 2nd decant | 1278 | | 0.3051 | 0.110 | 5.3 |
| 3rd decant | 1270 | | 0.0174 | 0.006 | 0.3 |
| 4th decant | 1300 | | 0.0090 | 0.003 | 0.2 |
| Total | | | | 1.440 | 69.5 |

### Example 3

trihexyl(tetradecyl)phosphonium dicyclohexylphosphinate

Trihexyl(tetradecyl)phosphonium dicyclohexylphosphinate was prepared according to the following method. A stirred jacketed reactor was charged with:

1.907 moles of trihexyl(tetradecyl)phosphonium chloride

(1017 g of CYPHOS 3653)

1.909 moles of di cyclohexylphosphinate

(349 g of di cyclohexylphosphinate) 2.417 moles) and

1200 g of water

After heating the mixture to 55° C., a 25% aqueous solution of sodium hydroxide (83.4 g sodium hydroxide (2.022 moles), 210 g water) was added over 30 minutes. The two phases were stirred for an additional 1 hr at 55° C.

The agitation was then turned off and the reaction mixture was allowed to separate into a two-phase system consisting of an upper organic phase and a lower aqueous phase (phase separation took about 4 minutes). The lower aqueous phase was decanted and the upper organic layer was washed three times by stirring with 1300 g of distilled water.

After washing and allowing the phases to separate, the organic layer was then vacuum stripped to remove dissolved water. Approximately 210 g of water (14% water by weight) was removed after vacuum stripping to 138° C. under 4 mmHG pressure. The final organic layer was perfectly clear.

### Results

The decanted aqueous phases were analyzed for chloride ion. The first decant removed 82.2% of the chloride ion, and the first, second, and third washes additionally removed 14.7%, 1.7%, and 0.2% of the chloride ion, respectively, for a total of 98.8% (see Table 3).

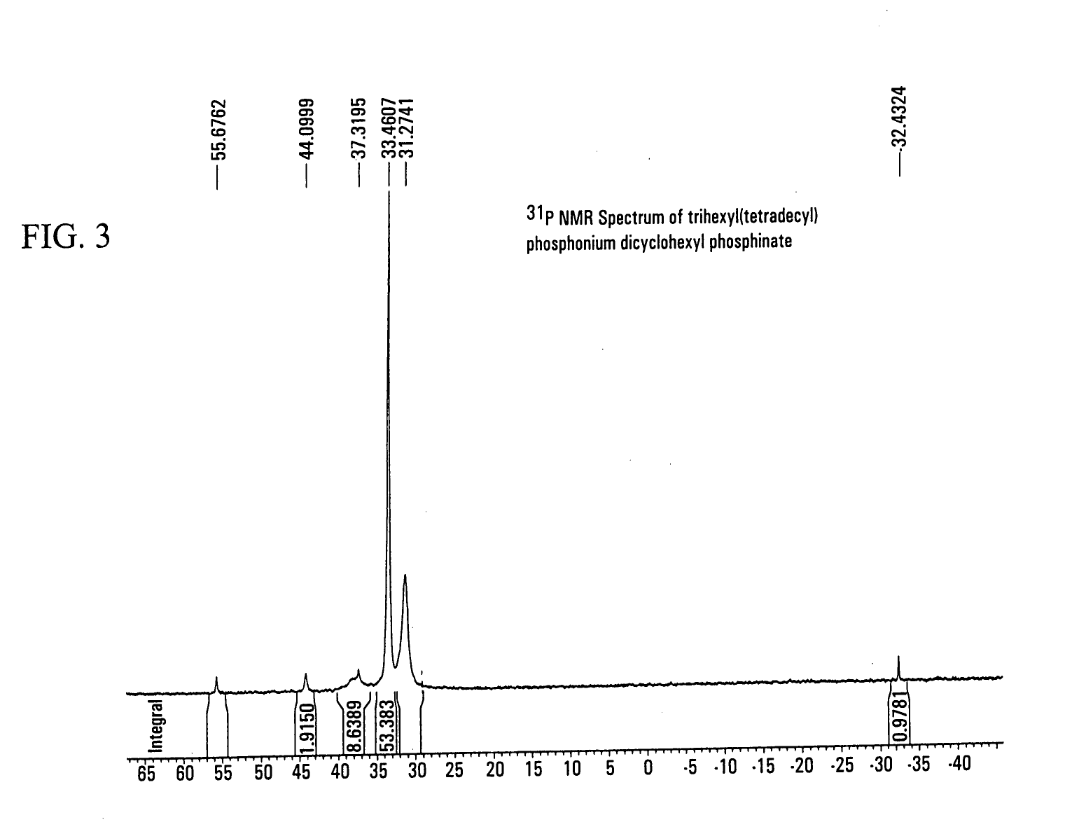

A sample of the organic layer was analyzed by ³¹p NMR (FIG. 3). The NMR spectrum indicates two distinct signals: +33.46 ppm for the phosphonium cation and +31.2741 ppm for the phosphinate anion, consistent with the reaction product trihexyl(tetradecyl)phosphonium di cyclohexylphosphinate.

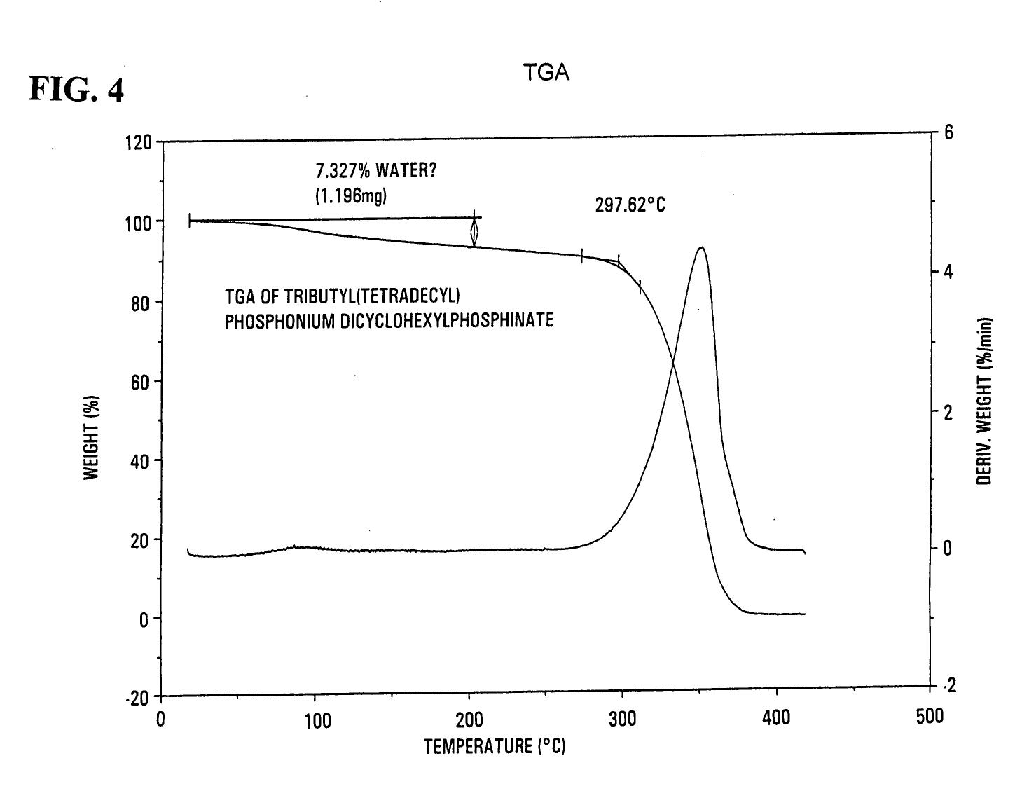

Samples of trihexyl(tetradecyl)phosphonium di cyclohexylphosphinate were analyzed by TGA and found to be thermally stable up to approximately 300° C. (see FIG. 4). This analysis also indicated that the product may contain as much as 7-8% moisture.

TABLE 3
Preparation of trihexyl(tetradecyl)phosphonium
dicyclohexylphosphinate

| | | |
|---|---|---|
| Dicyclohexylphosphinic | 98.0% R″₂P(O)OH | R″ = cyclohexyl |
| acid | | |
| CYPHOS 3653 | 97.2% R₃R′PCl | R = n-butyl |
| | 2.1% R₃PCl | R′ = n- |
| | | tetradecyl |
| | 0.2% HCl | |

| | Weight | | Chloride Balance | | % Cl |
|---|---|---|---|---|---|
| | (g) | Moles | % Cl | Moles Cl | Removed |
| R″₂P(O)OH | 439 | 1.909 | | 0.000 | |
| CYPHOS 3653 | 1017 | 1.907 | | 1.973 | |
| 97% NaOH | 83.4 | 2.022 | | 0.000 | |
| Water | 1200 | | | | |
| 1st decant | 1249 | | 4.6040 | 1.622 | 82.2 |
| 2nd decant | 1344 | | 0.7650 | 0.290 | 14.7 |
| 3rd decant | 1300 | | 0.0898 | 0.033 | 1.7 |
| 4th decant | 1310 | | 0.0090 | 0.003 | 0.2 |
| Total | | | | 1.948 | 98.8 |

TABLE 4
Water Stripping from Phosphonium Phosphinates

| | | Temperature | Pressure |
|---|---|---|---|
| R₃R′P R″P(O)OR″ | % Water Removed | (° C.) | (mmHg) |
| 2,4,4′- | 13.2 | 125 | 4 |
| trimethylpentyl | | | |
| isobutyl | 13.4 | 135 | 4 |
| cyclohexyl | 14.0 | 138 | 4 |

### Example 4

trihexyl(tetradecyl)phosphonium diisobutyl dithiophosphinate

Trihexyl(tetradecyl)phosphonium diisobutyl dithiophosphinate was prepared according to the following method. A stirred jacketed reactor was charged with:

1.91 moles of trihexyl(tetradecyl)phosphonium chloride

(1019 g of CYPHOS 3653)

1.99 moles of sodium diisobutyldithiophosphinate (925 g of AEROPHINE 3418A, a 50% aqueous solution of sodium diisobutyldithiophosphinate) and

1500 g of water

This mixture was heated to 50° C. and stirred for 30 minutes. The agitation was then turned off and the reaction mixture was allowed to separate into a two-phase system consisting of an upper organic phase and a lower aqueous phase (phase separation took about 4 minutes). The lower aqueous phase was decanted and the upper organic layer was washed three times by stirring with 1400 g of distilled water at 50° C.

The organic layer was then vacuum stripped to 125° C. at 1.2 mmHg pressure. Only 25 g of water was removed. The final organic layer was perfectly clear.

### Results

The final product was a liquid at room temperature. The chloride content was 0.0099%.

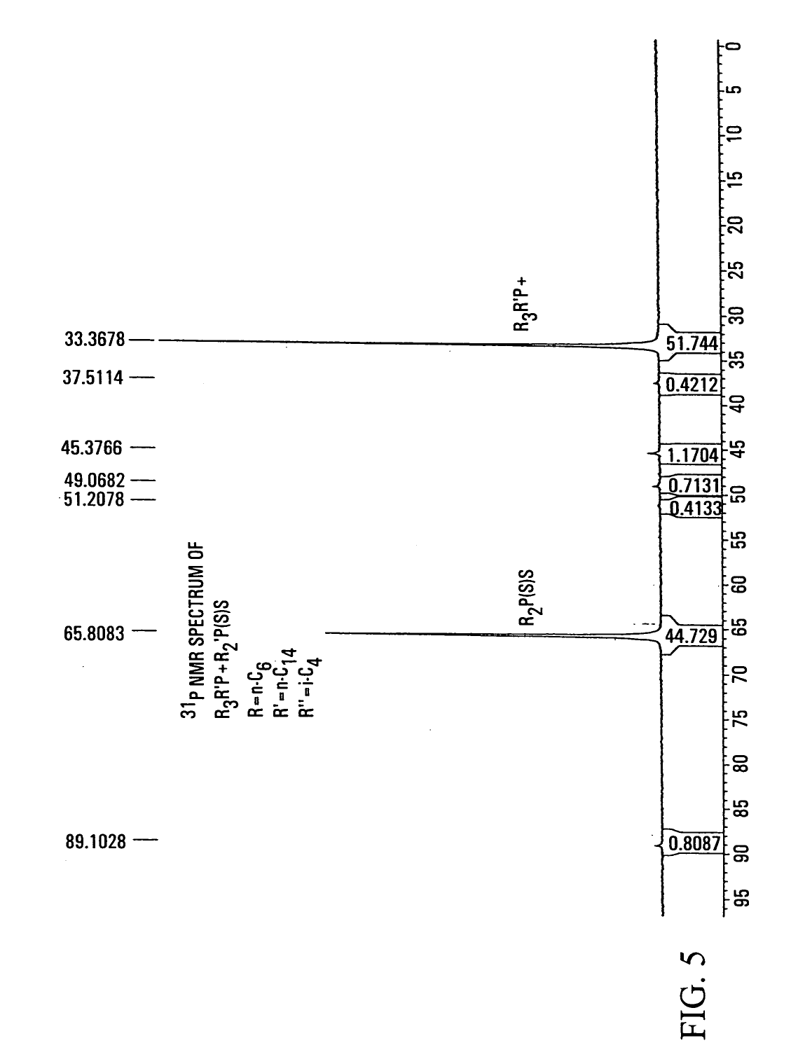

The ³¹p NMR spectrum indicated two distinct signals: +33.37 ppm, phosphonium cation; and +65.81 ppm, dithiophosphinate anion (FIG. 5).

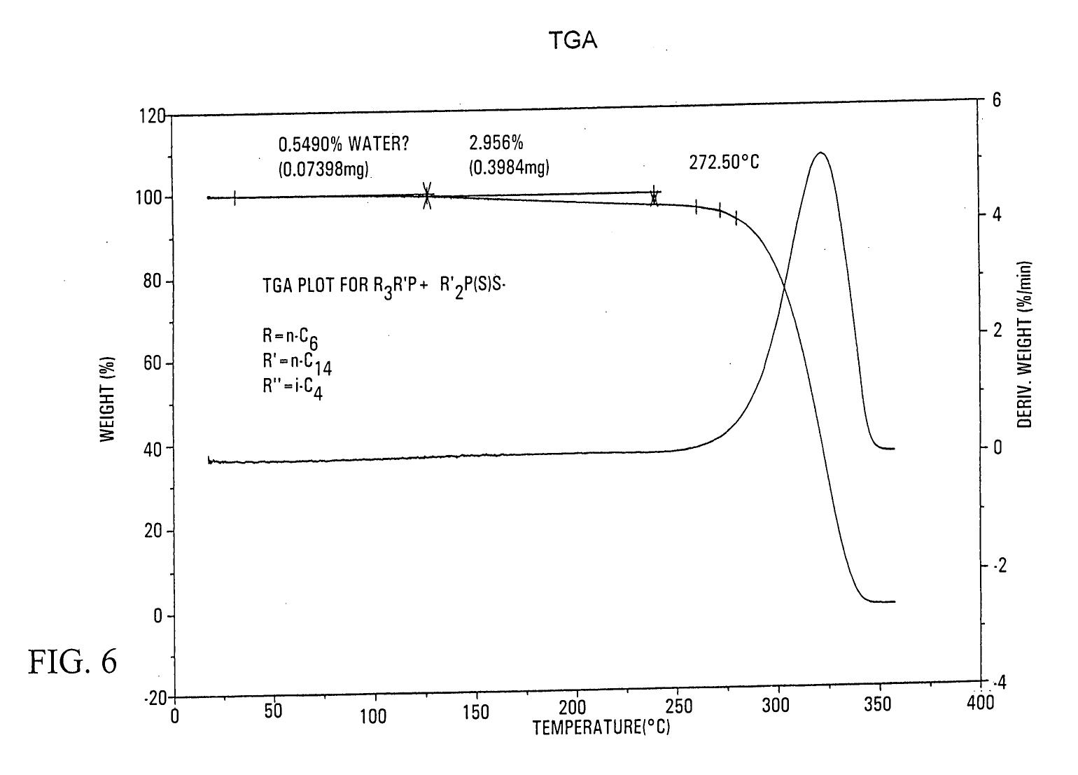

Samples of trihexyl(tetradecyl)phosphonium diisobutyldithiophosphinate were analyzed by TGA and found to be thermally stable up to approximately 270° C. (see FIG. 6). This analysis also indicated that the product contains approximately 0.5% water.

### Example 5

Biphenyl synthesis via homo-coupling of bromobenzene using Pd(OAc)₂ in various phosphonium ionic liquids

In this series of experiments, the homo-coupling of bromobenzene was carried out in various phosphonium ionic liquids. The reaction proceeds according to:

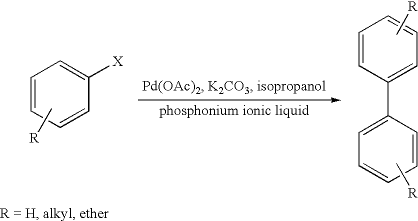

In the following experiments, a stirred jacketed reactor was charged with:

1.0 g bromobenzene

2.0 g isopropyl alcohol

1.5 g K₂CO₃

0.03 g of Pd(OAc)₂

The reagents were heated at 1200C for 16 hours in a phosphonium ionic liquid solvent selected from the group consisting of:

trihexyl(tetradecyl)phosphonium dicyclohexylphosphinate;

trihexyl(tetradecyl)phosphonium decanoate;

trihexyl(tetradecyl)phosphonium bis-(2,4,4′-trimethylpentyl)phosphinate;

trihexyl(tetradecyl)phosphonium triflamide; and

trihexyl(tetradecyl)phosphonium triflate.

The reaction mixture was allowed to cool, poured into 50 ml water, and the total reaction mixture was extracted with petroleum ether (at 45-60° C.). The ionic liquid formed a middle layer that could be recovered. The petroleum ether layer was washed with water, then with brine, and then concentrated. The residue was distilled to obtain the required biaryl compound.

Overall yield of biphenyl using the different solvents was evaluated and is tabulated in Table 5. The yield of biphenyl varied considerably with choice of solvent. However, the two experiments in which phosphonium phosphinate compounds were used as solvents provided substantially higher yields than comparative experiments in which phosphonium triflamide or triflate were used as solvents, thus demonstrating the suitability of the compounds of the current invention for use in biphenyl synthesis via homo-coupling of bromobenzene using Pd(OAc)₂. Reaction conditions were not optimized for any particular solvent, and it is reasonable to expect that overall yields could be improved.

TABLE 5
Biphenyl synthesis via homo-coupling of bromobenzene using
Pd(OAc)2 in various phosphonium ionic liquids

| Exp. No. | Ionic Liquid | % Yield |
|---|---|---|
| 1 | trihexyl(tetradecyl)phosphonium | 61 |
| | dicyclohexylphosphinate | |
| 2 | trihexyl(tetradecyl)phosphonium decanoate | 100 |
| 3 | trihexyl(tetradecyl)phosphonium bis- | 52 |
| | (2,4,4-trimethylpentyl)phosphinate | |
| 4 | trihexyl(tetradecyl)phosphonium triflamide | 26 |
| 5 | trihexyl(tetradecyl)phosphonium triflate | 9 |

### Example 6

Biphenyl synthesis via homo-coupling of iodobenzene in various ionic liquids using Pd(OAc)₂ as catalyst

The following reaction is analogous to the reaction in Example 5, except that it is performed using iodobenzene as a starting material.

A stirred jacketed reactor was charged with:

1.0 g iodobenzene

1.5 g isopropyl alcohol

1.5 g K₂CO₃

0.03 g of Pd(OAc)₂

The reagents were heated at 120° C. for 18 hours in a phosphonium ionic liquid solvent selected from the group consisting of:

trihexyl(tetradecyl)phosphonium chloride;

trihexyl(tetradecyl)phosphonium triflate;

trihexyl(tetradecyl)phosphonium triflamide;

trihexyl(tetradecyl)phosphonium bis-(2,4,4′-trimethylpentyl)phosphinate;

trihexyl(tetradecyl)phosphonium dicyclohexylphosphinate;

trihexyl(tetradecyl)phosphonium diisobutylphosphinate;

trihexyl(tetradecyl)phosphonium decanoate;

trihexyl(tetradecyl)phosphonium tetrafluoroborate; and

trihexyl(tetradecyl)phosphonium hexaflurophosphate.

Overall yield of biphenyl using the different solvents was evaluated and is tabulated in Table 6. The yield of biphenyl varied considerably with choice of solvent. Use of trihexyl(tetradecyl)phosphonium chloride as solvent results in a particularly low yield of biphenyl because chloride ions interfere with the Pd(OAc)₂ catalyst. When phosphonium phosphinate compounds according to the current invention are used as solvents, the reaction proceeds with high yields, on the order of about 100%. These results demonstrate that phosphonium phosphinate compounds do not interfere with the Pd(OAc)₂ catalyst and therefore are suitable solvents for biphenyl synthesis via homo-coupling of iodobenzene using Pd(OAc)₂ as a catalyst.

TABLE 6
Homo-coupling of iodobenzen in various ionic liquids using
Pd(OAc)2 catalyst

| Exp. No. | Ionic Liquid | % Conversion |
|---|---|---|
| 1 | trihexyl(tetradecyl)phosphonium chloride | 13 |
| 2 | trihexyl(tetradecyl)phosphonium triflate | 100 |
| 3 | trihexyl(tetradecyl)phosphonium triflamide | 72 |
| 4 | trihexyl(tetradecyl)phosphonium bis- | 78 |
| | (2,4,4-trimethylpentyl)phosphinate | |
| 5 | trihexyl(tetradecyl)phosphonium | 100 |
| | dicyclohexylphosphinate | |
| 6 | trihexyl(tetradecyl)phosphonium | 100 |
| | diisobutylphosphinate | |
| 7 | trihexyl(tetradecyl)phosphonium decanoate | 100 |
| 8 | trihexyl(tetradecyl)phosphonium | 56 |
| | tetrafluoroborate | |
| 9 | trihexyl(tetradecyl)phosphonium | 50 |
| | hexafluorophosphate | |

### Example 7

Heck coupling of iodobenzene and methylacrylate in various ionic liquids using Pd(OAc)₂ catalyst

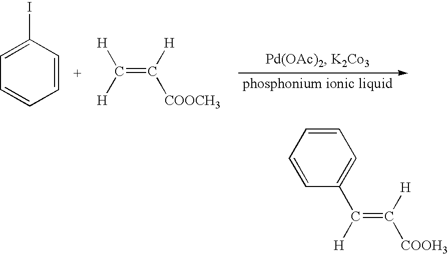

A stirred jacketed reactor was charged with:

1.0 g iodobenzene

0.86 g methylacrylate

2.0 g K₂CO₃

0.05 g of Pd(OAc)₂

The reaction mixture was heated at 80° C. for 14 hours in 2.0 g of a phosphonium ionic liquid solvent selected from the group consisting of:

trihexyl(tetradecyl)phosphonium chloride;

trihexyl(tetradecyl)phosphonium triflate;

trihexyl(tetradecyl)phosphonium triflamide;

trihexyl(tetradecyl)phosphonium bis-(2,4,4′-trimethylpentyl)phosphinate;

trihexyl(tetradecyl)phosphonium dicyclohexylphosphinate;

trihexyl(tetradecyl)phosphonium diisobutylphosphinate;

trihexyl(tetradecyl)phosphonium decanoate;

trihexyl(tetradecyl)phosphonium tetrafluoroborate; and

trihexyl(tetradecyl)phosphonium hexaflurophosphate.

Overall yield is tabulated in Table 7. The yield of the reaction varied considerably with choice of solvent. Yields on the order of about 100% were obtained using three of the phosphonium phosphinate solvents of the current invention, thus demonstrating that phosphonium phosphinate compounds provide suitable solvents for Heck coupling reactions.

An analogous series of experiments was performed using ethylacrylate instead of methylacrylate. The results of these experiments,are tabulated in Table 8. In general, the Heck coupling of iodobenzene and ethylacrylate gave lower yields than the coupling of iodobenzene with methylacrylate. However, it is clear from these experiments that the phosphonium phosphinate compounds of the current invention provide suitable solvents for this Heck coupling reaction.

TABLE 7
Heck coupling of iodobenzene and methylacrylate in
various ionic liquids using Pd(OAc)2 catalyst

| Exp. No. | Ionic Liquid | % Conversion |
|---|---|---|
| 1 | trihexyl(tetradecyl)phosphonium chloride | 82 |
| 2 | trihexyl(tetradecyl)phosphonium triflate | 92 |
| 3 | trihexyl(tetradecyl)phosphonium triflamide | 62 |
| 4 | trihexyl(tetradecyl)phosphonium bis- | 100 |
| | (2,4,4-trimethylpentyl)phosphinate | |
| 5 | trihexyl(tetradecyl)phosphonium | 100 |
| | dicyclohexylphosphinate | |
| 6 | trihexyl(tetradecyl)phosphonium | 100 |
| | diisobutylphosphinate | |
| 7 | trihexyl(tetradecyl)phosphonium decanoate | 100 |
| 8 | trihexyl(tetradecyl)phosphonium | 60 |
| | tetrafluoroborate | |
| 9 | trihexyl(tetradecyl)phosphonium | 82 |
| | hexafluorophosphate | |

TABLE 8
Heck coupling of iodobenzene and ethylacrylate in various ionic
liquids using Pd(OAc)2 catalyst

| Exp. No. | Ionic Liquid | % Conversion |
|---|---|---|
| 1 | trihexyl(tetradecyl)phosphonium chloride | 42 |
| 2 | trihexyl(tetradecyl)phosphonium triflate | 78 |
| 3 | trihexyl(tetradecyl)phosphonium triflamide | 52 |
| 4 | trihexyl(tetradecyl)phosphonium bis- | 84 |
| | (2,4,4-trimethylpentyl)phosphinate | |
| 5 | trihexyl(tetradecyl)phosphonium | 10 |
| | dicyclohexylphosphinate | |
| 6 | trihexyl(tetradecyl)phosphonium | 86 |
| | diisobutylphosphinate | |
| 7 | trihexyl(tetradecyl)phosphonium decanoate | 87 |
| 8 | trihexyl(tetradecyl)phosphonium | 35 |
| | tetrafluoroborate | |
| 9 | trihexyl(tetradecyl)phosphonium | 76 |
| | hexafluorophosphate | |

### Example 8

Carbonylation of iodobenzene in various ionic liquids using Pd(OAc)₂ catalyst The general reactiQn proceeds as follows:

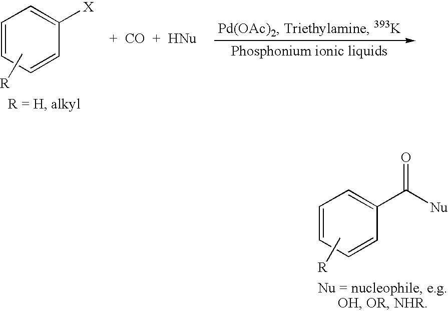

R=H, alkyl Nu=nucleophile, e.g. OH, OR, NHR.

A stirred jacketed reactor was charged with: 1.0 g iodobenzene, 3 equivalents of triethylamine, 6 equivalents of ethanol, a catalytic amount of Pd(OAc)₂ and 2.0 g of a phosphonium ionic liquid. The reaction mixture was heated at 120° C. for 14 hours under 5 bar CO partial pressure. After 14 hours, the reaction mixture was brought to room temperature, and the total reaction mixture was poured into water. The reaction mixture was extracted using petroleum ether (3×30 ml), the total organic phase was washed with water and concentrated in vacuo followed by the distillation under reduced pressure. The ethylbenzoate product was recovered in nearly quantitative yield.

For these experiments, the phosphonium ionic liquid solvent selected from the group consisting of:

trihexyl(tetradecyl)phosphonium chloride;

trihexyl(tetradecyl)phosphonium triflate;

trihexyl(tetradecyl)phosphonium triflamide;

trihexyl(tetradecyl)phosphonium bis-(2,4,4′-trimethylpentyl)phosphiriate;

trihexyl(tetradecyl)phosphonium decanoate; and

butylmethylimidazolium [bmin] hexafluorophosphate.

As shown in Table 9, all of the ionic liquids gave nearly quantitative yields of the required product material with the complete consumption of the starting iodobenzene. In the case of trihexyl(tetradecyl)phosphonium decanoate, a mixture of products was obtained wherein 50% of the product was a decanoate ester and 50% was the expected ethyl ester; apparently the decanoate anion acts as a nucleophile and attacks the intermediate Ar—Pd—CO—X species.

These experiments demonstrate the particular suitability of the phosphonium phosphinate compounds of the current invention for palladium catalyzed carbonylation of aryl halides.

TABLE 9
Carbonylation of iodobenzene in various ionic liquids using
Pd(OAc)2 catalyst

| Exp. No. | Ionic Liquid | % Yield |
|---|---|---|
| 1 | trihexyl(tetradecyl)phosphonium chloride | 100 |
| 2 | trihexyl(tetradecyl)phosphonium triflate | 97 |
| 3 | trihexyl(tetradecyl)phosphonium triflamide | 100 |
| 4 | trihexyl(tetradecyl)phosphonium bis- | 100 |
| | (2,4,4-trimethylpentyl)phosphinate | |
| 5 | trihexyl(tetradecyl)phosphonium decanoate | 50 + 50 |
| 6 | [bmin] hexafluorophosphate | 78 |

### Example 9

Bipyridine synthesis via the homo-coupling of bromopyridine in various ionic liquids using Pd(OAc)₂ catalyst

A stirred jacketed reactor was charged with:

1.0 g bromopyridine

2.0 g isopropanol

1.5 g K₂CO₃

0.03 g of Pd(OAc)₂

The reaction mixture was heated at 120° C. for 36 hours in a phosphonium ionic liquid solvent selected from the group consisting of:

trihexyl(tetradecyl)phosphonium triflate;

trihexyl(tetradecyl)phosphonium triflamide;

trihexyl(tetradecyl)phosphonium bis-(2,4,4′-trimethylpentyl)phosphinate;

trihexyl(tetradecyl)phosphonium dicyclohexylphosphinate; and

trihexyl(tetradecyl)phosphonium decanoate.

Overall yield of bipyridine using the different solvents was evaluated and is tabulated in Table 10. The yield of bipyridine varied considerably with choice of solvent. Good yields were obtained using phosphonium phosphinate compounds of the current invention as solvents, thus demonstrating the suitability of these compounds for use in bipyridine synthesis via the homo-coupling of bromopyridine in various ionic liquids using Pd(OAc)₂ catalyst.

TABLE 10
Bipyridin synthesis via the homo-coupling of bromopyridin
using Pd(OAc)2 catalysis in various phosphonium ionic liquids

| Exp. No. | Ionic Liquid | % Yield |
|---|---|---|
| 1 | trihexyl(tetradecyl)phosphonium | 52 |
| | dicyclohexylphosphinate | |
| 2 | trihexyl(tetradecyl)phosphonium decanoate | 100 |
| 3 | trihexyl(tetradecyl)phosphonium bis- | 52 |
| | (2,4,4-trimethylpentyl)phosphinate | |
| 4 | trihexyl(tetradecyl)phosphonium triflamide | 43 |
| 5 | trihexyl(tetradecyl)phosphonium triflate | 36 |

1. A compound of the formula (I): 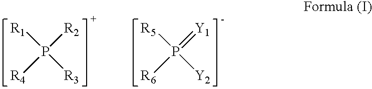
wherein:
each of R₁, R₂, R₃, R₄, R₅, and R6 is independently a hydrogen atom or a hydrocarbyl groups, provided that not more than two of R₁ to R₄ and not more than one of Rs and R₆ are hydrogen;
Y₁ is O or S; and
Y₂ is O or S.

2. A compound of claim l.wherein each of R₁, R₂, R₃, R₄, R₅, and R₆ is independently an alkyl group of 1 to 30 carbon atoms, a cycloalkyl group of 3 to 7 carbons, an alkenyl group of 2 to 30 carbon atoms, an alkynyl group of 2 to 30 carbon atoms, an aryl group of 6 to 18 carbon atoms, or an aralkyl group.

3. A compound of claim 2 wherein each of R₁, R₂, R₃, and R₄, is independently an alkyl group of 5 to 20 carbon atoms.

4. A compound of claim 3 wherein each of R₁, R₂, and R₃ is n-hexyl and R₄ is n-tetradecyl.

5. A compound of any one of claims 1 to 4 wherein each of R₅ and R₆ is independently an alkyl group of 1 to 30 carbon atoms, an alkenyl group of 2 to 30 carbon atoms, an alkynyl group of 2 to 30 carbon atoms, an aryl group of 6 to 18 carbon atoms, or an aralkyl group.

6. A compound of claim 5 wherein each of R₅ and R₆ is independently an alkyl group of 5 to 20 carbon atoms.

7. A compound of claim 1 wherein R₅ and R6 are 2,4,4′-trimethylpentyl and Y₁ and Y₂ are O.

8. A compound of claim 1 wherein Rs and R₆ are isobutyl and Y₁ and Y₂ are O.

9. A compound of claim 1 wherein R₅ and R₆ are cyclohexyl and Y₁ and Y₂ are O.

10. A compound of claim 1 wherein R₅ and R₆ are isobutyl and Y₁ and Y₂ are S.

11. A compound of any one of claims 1 to 10 wherein the total number of carbons in R₁, R₂, R₃, R₄, R₅, and R₆ is 25 or more.

12. A compound of any one of claims 1 to 11 wherein the total number of carbons in R₁, R₂, R₃, R₄, R₅, and R₆ is 40 or more.

13. A compound of any one of claims 1 to 12 that is immiscible with water.

14. A compound of any one of claims 1 to 9 wherein Y₁ and Y₂ are both O.

15. A compound of any one of claims 1 to 6 and 10, wherein Y₁ and Y₂ are both S.

16. A method for preparing a phosphonium phosphinate compound of formula (I), as defined in claim 1, wherein:
i) a compound of formula (II): 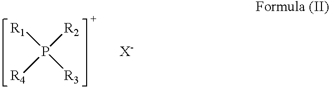
wherein R₁ to R₄ are as defined in claim 1, and
X⁻ is a leaving group, is reacted with
ii) a compound of the formula (IV): 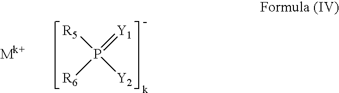
wherein, R₅, R₆, Y₁ and Y₂ are defined in claim 1, and
M^{k+} is H⁺ or a metal cation with valency “k”.

17. The method according to claim 16 wherein M^{k+} is H⁺ and X⁻ is OH⁻.

18. The method according to claim 16 wherein M^{k+} is H⁺ and X⁻ is a leaving group other than OH⁻ and the reaction is carried out in the presence of a base.

19. The method according to claim 16 wherein M^{k+} is a metal cation with valency “k” and X⁻ is a leaving group other than OH⁻.

20. Use of the compound of any one of claims 1 to 15 as a solvent.
